(19) United States
(12) Patent Application Publication
(10) Pub. No.: US 2007/0052805 A1
(43) Pub. Date: Mar. 8, 2007

(54) Interior mirror

(75) Inventors: Bunji Inagaki, Aichi-ken (JP); Hiromitsu Mizuno, Aichi-ken (JP)

Correspondence Address: ROBERTS, MLOTKOWSKI & HOBBES, P. O. BOX 10064, MCLEAN, VA, 22102-8064, US

(73) Assignee: Kabushiki Kaisha Tokai-Rika-Denki-Seisakusho, Aichi-ken (JP)

(21) Appl. No.: 10/683,111

(22) Filed: Oct. 14, 2003

(30) Foreign Application Priority Data
Oct. 17, 2002 (JP) 2002-302713
Oct. 17, 2002 (JP) 2002-302714
Oct. 17, 2002 (JP) 2002-302715

(51) Int. Cl. H04N 7/18; G02B 13/16

(52) U.S. Cl. 348/148; 348/335

(57) ABSTRACT

An interior mirror which enables surveillance of a vehicle driver even at night, in tunnels and the like, without obstructing a forward field of vision of the vehicle driver or subjecting the vehicle driver to psychological pressure due to the presence of a surveillance device. Light with wavelengths in the infra-red light region is illuminated from infra-red LEDs inside a housing. When this light enters a filter from a rear face side thereof, the infra-red light that has wavelengths outside a range X is reflected, and the infra-red light that has wavelengths inside the range X is transmitted. This transmitted infra-red light is irradiated at the vehicle driver. This infra-red light is reflected from the vehicle driver, is incident at the filter from the front face side thereof and is again transmitted to the rear face side, and enters a lens of an infra-red camera.

### CROSS-REFERENCE TO RELATED APPLICATION

This application claims priority under 35USC 119 from Japanese Patent Applications Nos. 2002-302713, 2002-302714 and 2002-302715, the disclosures of which are incorporated herein by reference.

### BACKGROUND OF THE INVENTION

1. Field of the Invention

The present invention relates to an interior mirror mounted at a vehicle or the like.

2. Description of the Related Art

Surveillance devices which capture images of vehicle operators, process the obtained images and detect sleepiness, inattentiveness and the like are conventionally known. For example, Japanese Patent Application Laid-Open (JP-A) No. 60-168004 discloses a technology which provides a light-emitting element and a CCD image capture element at a corner upward and left of a passenger (or assistant operator) seat in a vehicle cabin, and detects a position of an operator in three dimensions from images obtained by image-capturing the vehicle operator.

However, in a case in which a surveillance device is provided at a corner upward and left of the passenger seat in a vehicle cabin or the like, because the vehicle operator is to be image-captured at all times regardless of body characteristics, seat position and the like of the vehicle operator, it is necessary to widen an imaging angle of an image capture system lens or to adjust the camera position to match the circumstances of the operator. Circumstantial adjustment of the camera position is complex, and there may be cases in which it is not possible to capture the operator correctly. Moreover, if the imaging angle of the image capture system lens is widened, an imaging region corresponding to an eye area of the operator is made relatively smaller, and there are problems in that determination of an eyeline direction of the operator and determination of whether the operator is awake or asleep are made more difficult.

In consequence, there are devices in which a CCD camera, an infra-red LED and the like are provided together at an interior mirror such as a rear view mirror or the like of a vehicle.

For example, at an interior mirror disclosed in JP-A No. 11-331653, a CCD camera is disposed inside the interior mirror and an infra-red LED is provided protruding to outside the interior mirror. Hence, when an operator sits in a seat and adjusts the interior mirror, an optical axis of the CCD camera is automatically djusted therewith. As a result, the operator can be reliably captured regardless of the body characteristics, seat position and the like of the operator. Thus, subsequent image processing is simple, and it is possible to detect the state of the operator with high accuracy. Furthermore, because light other than visible light, for example, infra-red light, is illuminated, the operator can be captured even at night, in tunnels and the like.

However, with the interior mirror disclosed in JP-A No. 11-331653, a light-emitting section (the infra-red LED) protrudes to the outside of the interior mirror, and makes a projected area of a front face portion of the interior mirror larger. Consequently, appearance thereof is adversely affected, in addition to which a field of forward vision of the operator is obstructed. Further, if the operator is reminded of the presence of the surveillance device, the operator may be disturbed by the surveillance, and may be subjected to a feeling of psychological pressure.

Provision of such surveillance devices inside interior mirrors is conventionally known. For example, at an interior mirror disclosed in Japanese Utility Model Application Laid-Open (JP-U) No. 6-12199, by providing a surveillance device inside an interior mirror, the surveillance device can be disposed so as not to be troublesome to an operator in a vehicle cabin. Thus, capture of facial images of the vehicle operator and observation of changes in the facial images are enabled by the surveillance device provided inside the interior mirror.

Further, if a light-emitting section which emits infra-red light or the like is disposed inside the interior mirror with the surveillance device, the field of vision of the operator is improved relative to a case in which the light-emitting section is provided to protrude to outside the interior mirror.

However, in a case in which the light-emitting section is disposed together with the surveillance device inside the interior mirror, illumination light from the light-emitting section and reflection light, which has been illuminated from the light-emitting section and reflected by a filter, are incident on the lens of the surveillance device, and there may be flare (white fogging) in the images. When flare occurs, the images are fogged white and lose their usefulness as images for the surveillance device. In particular, in cases in which warping or dimensional errors arise in fabrication of structural members of the interior mirror, a gap may be formed between the filter and the lens of the surveillance device. Light from the light-emitting section may leak in through this gap, and there is a high possibility that unwanted light may be incident on the lens of the surveillance device.

Anyway, if a light-emitting section such as an infra-red LED or the like is disposed inside the interior mirror with a CCD camera, a field of vision of the operator is improved in comparison with a case in which the infra-red LED or the like is provided protruding to outside the interior mirror. However, because it is necessary for the infra-red light illuminated from the infra-red LED to pass through a filter, a filter with high transmissivity for the infra-red light is preferable.

However, at a facial area of the operator during driving, the facial area is illuminated with various kinds of light which are constantly changing (interference such as sunlight, light from lamps of oncoming vehicles and the like). Thus, contrast of, for example, shadow portions which arise at the face of the operator in accordance with this changing light also changes. Consequently, it is difficult for images at the CCD camera to be made stable, and there is a problem in that clear images are not provided.

Accordingly, there is a need for projection of infra-red light and, at the interior mirror at which the CCD camera and the infra-red LED are incorporated, it is preferable to employ a filter with high transmissivity only for infra-red light with wavelengths in a predetermined range which is appropriate to the CCD camera.

However, the filter which is highly transmissive only of infra-red light of wavelengths in the predetermined range appropriate to the CCD camera is highly reflective of light of wavelengths in the visible light region. Therefore, if such a filter is employed as a filter for an interior mirror, there is a problem in that, when light is received from behind, reflected light is dazzling for the operator.

Further, in order to provide a filter which is highly transmissive only of infra-red light with wavelengths in the predetermined range, it is necessary to form a number of vapor-deposition films over the whole of the filter. However, if the filter is as large as the interior mirror, vapor-depositing numerous uniform layers over the whole of the filter is difficult, and the occurrence of defective products in which there are variations in the thickness of the films is likely. Consequently, production yields deteriorate, and it is necessary to discard defective products. Therefore, there is a problem in that overall costs of the filter are higher.

Filters with anti-dazzle effects have been conventionally employed as filters for interior mirrors. For example, filters which have spectral characteristics such that reflectivity in the visible light region is of the order of 50% (and transmissivity is around 50%) are employed. In other words, in the visible light region, around 50% of light that is illuminated to the filter is transmitted, and the remaining around 50% is reflected. Thus, even when light is received from rearward of the vehicle, the operator is not dazzled. In contrast, in the infra-red light region, infra-red light of wavelengths suitable for the CCD camera is transmitted.

As described above, in a case in which a surveillance device such as a CCD camera or the like and a light-emitting section such as an infra-red LED or the like are provided at the inside of an interior mirror, it is preferable if spectral characteristics of a filter are such that reflectivity of visible light is kept down at around 50% while transmssivity of infra-red light of wavelengths in a predetermined range, which is appropriate to the surveillance device, is higher. However, there is a problem in that achieving these two characteristics together is difficult.

### SUMMARY OF THE INVENTION

In consideration of the circumstances described above, an object of the present invention is to provide an interior mirror which does not obstruct a field of forward vision of a vehicle operator or cause a feeling of psychological pressure in the vehicle operator due to the presence of a surveillance device, and which enables surveillance of the vehicle operator, even at night, in tunnels and the like.

Another object of the present invention is to provide an interior mirror at which, even if a light-emitting section is disposed together with a surveillance device inside the interior mirror, unwanted light is not incident on a lens of the surveillance device and flare (white fogging) of an image does not occur.

A further object of the present invention is to provide an interior mirror at which a surveillance device which expresses remarkable contrast is incorporated, which provides an anti-dazzle effect due to suitable reflectivity and which is capable of providing stable images in which effects due to interference are slight.

In order to achieve the objects described above, according to a first aspect of the present invention, an interior mirror is provided which includes: a housing including an opening; a mirror including a mirror face and a mirror rear face at opposite sides thereof, the mirror being disposed so as to fill the opening of the housing, and the mirror including functionality as a filter which substantially reflects light of wavelengths in a visible light region that is incident from the mirror face side and substantially transmits light of wavelengths in an infra-red light region that is incident from either of the mirror face side and the mirror rear face side; an image capture section disposed in the housing; and a light-emitting section disposed in the housing, and capable of illuminating light including a wavelength in the infra-red light region at the mirror rear face.

According to a second aspect of the present invention, an interior mirror is provided which includes: a mirror including a mirror face and a mirror rear face at opposite sides thereof, the mirror including functionality as a filter which substantially reflects visible light that is incident from the mirror face side and substantially transmits light other than visible light; an image capture section including a lens facing the mirror rear face; a light-emitting section disposed at the mirror rear face side of the mirror, and capable of illuminating light other than visible light at the mirror rear face; and a shading member disposed between the lens and the light-emitting section, and capable of substantially preventing direct and indirect intrusion at the lens of illumination light from the light-emitting section.

According to a third aspect of the present invention, an interior mirror is provided which includes: a mirror including a mirror face and a mirror rear face at opposite sides thereof, the mirror including functionality as a first filter whose transmissivity and reflectivity of light of wavelengths in a visible light region are approximately equal, and whose transmissivity of light of wavelengths in an infra-red light region is high; an image capture section disposed at the mirror rear face side of the mirror; a light-emitting section disposed at the mirror rear face side of the mirror, and capable of illuminating light including a wavelength in the infra-red light region at the mirror rear face; and a second filter disposed between the mirror and the image capture section.

### BRIEF DESCRIPTION OF THE DRAWINGS

FIG. 1 is an exploded perspective view showing an interior mirror relating to a first embodiment.

FIG. 2 is a graph showing variation characteristics of reflectivity and transmissivity of a filter relating to the first embodiment.

FIG. 3 is an exploded perspective view showing an interior mirror relating to a second embodiment.

FIG. 4 is a sectional view showing principal elements of the interior mirror relating to the second embodiment.

FIG. 5 is an exploded perspective view showing an interior mirror relating to a third embodiment.

FIG. 6 is a sectional view showing principal elements of the interior mirror relating to the third embodiment.

FIG. 7 is a graph showing variation characteristics of reflectivity and transmissivity of a first filter relating to the third embodiment.

FIG. 8 is a graph showing variation characteristics of reflectivity and transmissivity of a second filter relating to the third embodiment.

FIG. 9 is a graph showing variation characteristics of reflectivity and transmissivity in a case in which spectral characteristics of the first filter relating to the third embodiment and spectral characteristics of the second filter are combined.

### DETAILED DESCRIPTION OF THE INVENTION

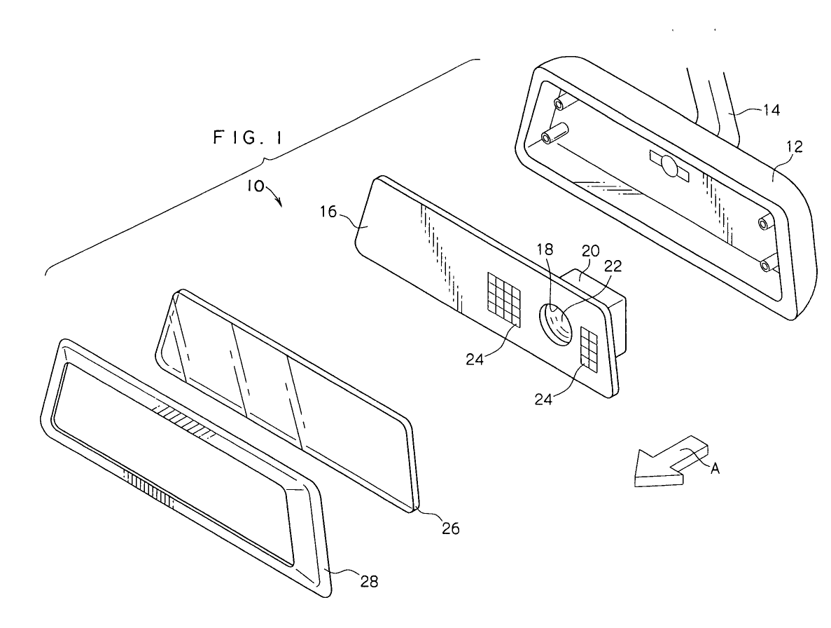

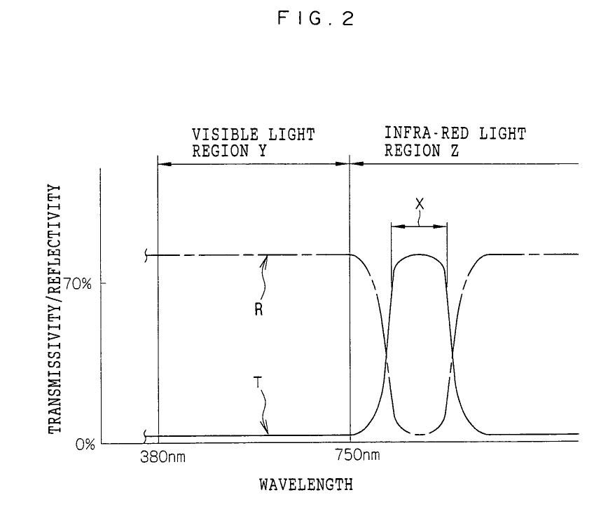

Herebelow, a first embodiment of the present invention will be described in detail with reference to FIGS. 1 and 2.

Referring to FIG. 1, an interior mirror 10 includes a housing 12. The housing 12 is formed in a substantially rectangular bowl shape featuring a floor portion and an outer periphery portion. The housing 12 opens to a forward side (the direction of arrow A in FIG. 1 which may be a rearward direction relative to motion of the vehicle).

A stay 14 is attached at a length direction central portion of a floor portion outer surface (a rear surface) at a rear face side of the housing 12 (a side thereof facing in a direction opposite to the direction of arrow A in FIG. 1). The housing 12 is fixed by the stay 14 to a ceiling or the like in a vehicle cabin.

A substantially rectangular flat plate-form baseplate 16 is fitted in at an opening portion of the housing 12. The baseplate 16 is supported by support members protruding inside the housing 12. A rear face of the baseplate 16 is covered by the housing 12.

A circular through-hole portion 18 is provided at one length direction side (the right side in FIG. 1) of a front face (surface) of the baseplate 16.

An infra-red camera 20, which is a surveillance device, is provided at the rear face of the baseplate 16 so as to be disposed inside the housing 12.

The infra-red camera 20 includes a lens 22. The lens 22 is disposed to be concentric with the through-hole portion 18. The lens 22 is exposed to the front face side through the through-hole portion 18, and an optical axis of the lens extends to the front face side of the baseplate 16.

Infra-red LEDs 24 are provided at portions of the front face of the baseplate, at both sides of the through-hole portion 18 in the length direction of the baseplate 16. The infra-red LEDs 24 serve as a light-emitting section, and irradiate infra-red light to the front face side. Image capture, even at night, in tunnels and the like, is enabled by these infra-red LEDs 24.

A substantially rectangular flat plate-form filter 26 is provided at the front face side of the baseplate 16 in order to cover the infra-red LEDs 24 and the front face of the baseplate 16. The infra-red LEDs 24 are disposed at the rear face side of the filter 26 inside the housing 12.

In FIG. 2, variations of reflectivity R and transmissivity T of the filter 26 when a wavelength of illuminating light is varied are shown by graphs. The solid line depicts the transmissivity T and the broken line depicts the reflectivity R.

As shown in FIG. 2, spectral characteristics of the filter 26 are that the reflectivity R is high (and the transmissivity T is low) for light with wavelengths in a visible light region Y. Further, in an infra-red light region Z, the transmissivity T is high (and the reflectivity R is low) for infra-red light with wavelengths in a range X which is appropriate to the infra-red camera 20 (specifically, light in a range of wavelengths from 850 nm to 950 nm), but the reflectivity R is high (and the transmissivity T is low) for infra-red light with wavelengths outside the range X. Thus, light passing through the filter 26 is limited to infra-red light with wavelengths in the range X that is appropriate for the infra-red camera 20.

A substantially rectangular cover 28 is provided at a front face side of the filter 26. The cover 28 includes a floor portion and a wall portion, and has a frame form in which a central portion of the floor portion is partially opened. The cover 28 is fixed to an edge portion of the opening of the housing 12. An outer edge portion of the filter 26 is retained by the cover 28, and a portion of the front face of the filter 26 is exposed through the opening portion of the cover 28.

Next, operation of the present embodiment will be described.

At the interior mirror 10 described above, light with wavelengths in the visible light region that is incident on the filter 26 is reflected. Thus, if, for example, the front face side of the filter 26 is oriented in a direction toward the vehicle operator, the vehicle operator can observe rearward by means of the light with wavelengths in the visible light region that is incident at the filter 26 from the front face side thereof and is reflected.

Light with wavelengths in the infra-red region is illuminated toward the front face side of the filter 26 from the infra-red LEDs 24 disposed in the housing 12 at the rear face side of the filter 26, and is incident at the filter 26 from the rear face side thereof. Here, infra-red light with wavelengths outside the range X is reflected, but infra-red light with wavelengths inside the range X is transmitted to the front face side of the filter 26. The infra-red light with wavelengths in the range X, which has passed through the filter 26, is irradiated toward the vehicle operator. The infra-red light with wavelengths in the range X is reflected at the vehicle operator, is incident at the filter 26 from the front face side thereof, and is again transmitted to the rear face side thereof. This infra-red light is incident at the lens 22 of the infra-red camera 20, whose optical axis is oriented toward the front face side of the filter 26.

In the present embodiment, the infra-red LEDs 24 are provided together with the infra-red camera 20 inside the housing 12, at the rear face side of the filter 26. Of the light with wavelengths in the infra-red region that is illuminated from the infra-red LEDs 24, the infra-red light with wavelengths in the range X, which is appropriate to the infra-red camera 20, passes through the filter 26. Thus, surveillance of the vehicle operator is enabled by this infra-red light. Moreover, a projected surface area of the front face portion of the interior mirror 10 can be made to be the same size as an ordinary interior mirror, and the presence of the infra-red camera 20 and the infra-red LEDs 24 is less likely to be noticed from outside the interior mirror 10.

Accordingly, a field of forward vision of the vehicle operator need not be hindered, the presence of the infra-red camera 20, which is the surveillance device, and the infra-red LEDs 24 can be effectively concealed, and a feeling of psychological pressure will not be invoked in the vehicle operator. Furthermore, surveillance of the operator is possible even at night, in tunnels and the like.

Further, because only the infra-red light with wavelengths in the range X which is appropriate to the infra-red camera 20 is incident at the infra-red camera 20, the filter 26, which is a reflection mirror, is effective in a role as a cutting filter for removing light with wavelengths that are not appropriate to the infra-red camera 20. As a result, incidence at the infra-red camera 20 of unwanted light (known as “interference”) which is not suitable for the infra-red camera 20, including various kinds of light illuminated at the vehicle operator during driving (sunlight, light from lamps of oncoming vehicles and the like), can be prevented. That is, the effects of interference on the infra-red camera 20 are slight and stable, and images with excellent contrast can be obtained.

As described above, with this interior mirror 10, because of the filter 26 which additionally features operation as a cutting filter, the vehicle operator can be image-captured and images obtained with clarity (in particular, images are stable with little influence from interference, and contrast is expressed to a remarkable degree), and the images can be analyzed more accurately. Thus, functionality as a surveillance device can be dramatically improved.

Now, in the present embodiment, the infra-red camera 20 and the infra-red LEDs 24 are provided at the right side in FIG. 1 of the baseplate 16. However, this is for a case in which a right-hand drive vehicle is assumed, and the present invention is not limited thus. Specifically, for a left-hand drive vehicle, the infra-red camera and infra-red LEDs may be provided at the left side of the baseplate. This also applies to the second and third embodiments described below.

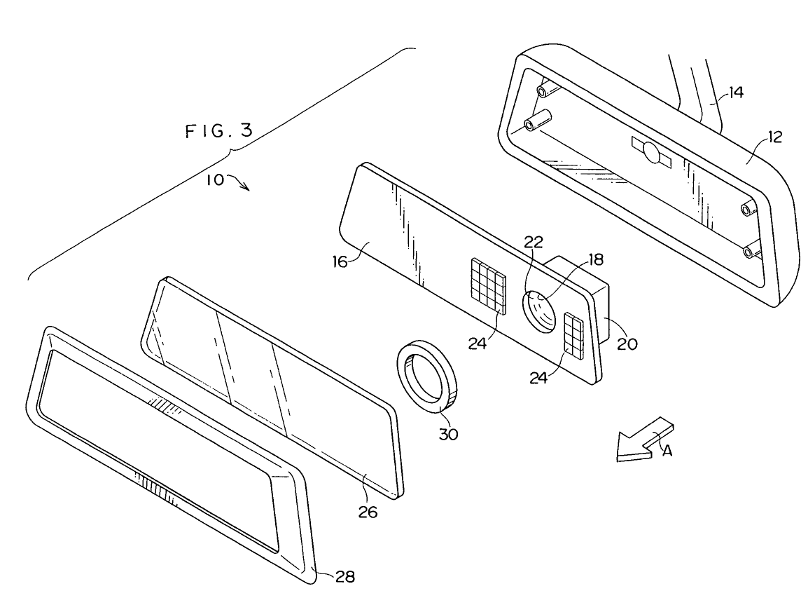

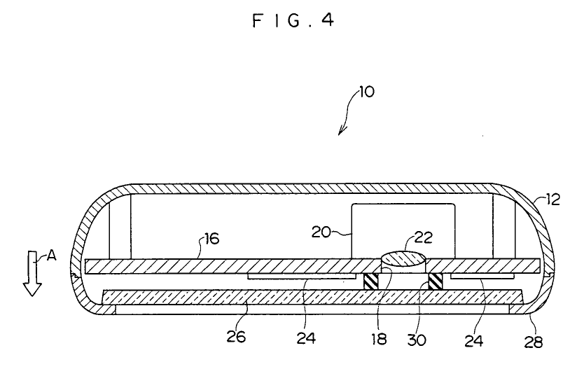

Now, a second embodiment of the present invention will be briefly described with reference to FIGS. 3 and 4. Note that components and portions that are the same as in the above-described first embodiment are assigned the same reference numerals, and duplicative explanations are omitted as appropriate.

Referring to FIGS. 3 and 4, a short tube-form shading member 30, which is compressible, is retained and mounted in a compressed state between the filter 26 and the baseplate 16. The shading member 30 has an inner diameter which is slightly larger than a hole diameter of the through-hole portion 18. The shading member 30 is located between the infra-red LEDs 24 at the two sides, and is disposed to be concentric with the through-hole portion 18. Thus, a field of view of the lens 22 of the infra-red camera 20 is excellently maintained by the inner periphery of the shading member 30.

The infra-red light illuminated from the infra-red LEDs 24 is transmitted from the rear face side to the front face side of the filter 26. The infra-red light that has passed through the filter 26 is illuminated to the vehicle operator, and infra-red light that is reflected from the vehicle operator is again transmitted from the front face side to the rear face side of the filter 26. This infra-red light passes through the tubular interior of the shading member 30, and is incident at the lens 22 which is exposed toward the filter 26. As a result, surveillance of the operator is possible even at night, in tunnels and the like.

Between the baseplate 16 and the filter 26, even if the infra-red light that has been irradiated from the infra-red LEDs 24 is oriented in a direction to directly enter the lens 22, this infra-red light is blocked by the shading member 30. In other words, the infra-red light irradiated from the infra-red LEDs 24 is prevented from entering into the lens 22.

Further, even if reflected light that is irradiated from the infra-red LEDs 24 and reflected by the filter 26 is oriented in a direction to indirectly enter the lens 22, this infra-red light is blocked by the shading member 30. In other words, reflected light that is illuminated from the infra-red LEDs 24 and reflected by the filter 26 is prevented from entering into the lens 22.

Thus, because incidence at the lens 22 of the infra-red camera 20 by infra-red light irradiated from the infra-red LEDs 24 and reflected light irradiated from the infra-red LEDs 24 and reflected by the filter 26 is prevented, the occurrence of flare (white fogging) of images is less likely to occur.

Further yet, the shading member 30 is sandwiched between the baseplate 16 and the filter 26 in the compressed state, and is tightly contacted with the baseplate 16 and the filter 26 by this compression. Therefore, even if significant errors in spacing between the filter 26 and the baseplate 16 arise during fabrication, gaps are unlikely to occur between the shading member 30 and the baseplate 16 or the filter 26. Accordingly, the incidence of unneeded light at the lens 22 of the infra-red camera 20 can be effectively prevented.

Hence, because there is no requirement for high accuracy of fabrication of the respective structural members of the interior mirror 10, fabrication is simpler and more economical.

Furthermore, because the shading member 30 has a simple form (a short tubular shape), the shading member 30 does not hinder the field of vision of the lens 22, is simple to fabricate and facilitates miniaturization.

Note that the filter 26 could be structured by an ordinary filter that simply reflects visible light and transmits infra-red light.

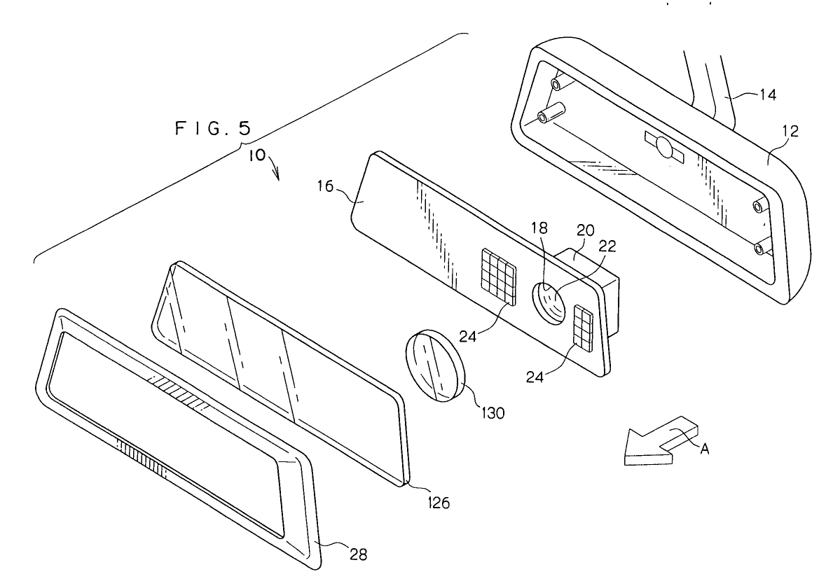

Now, a third embodiment of the present invention will be described in detail with reference to FIGS. 5 to 9. Note that components and portions that are the same as in the above-described first and second embodiments are assigned the same reference numerals, and duplicative explanations are omitted as appropriate.

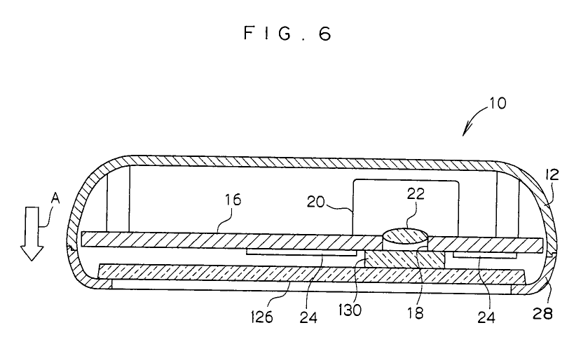

Referring to FIGS. 5 and 6, a first filter 126 is provided in order to cover the front face of the baseplate 16 and the infra-red LEDs 24. The first filter 126 has the same exterior profile and form as the filters in the above-described first and second embodiments. However, the first filter 126 has different optical characteristics, as described below.

A second filter 130 is provided between the first filter 126 and the baseplate 16. The second filter 130 has a circular plate form with an outer diameter slightly larger than the hole diameter of the through-hole portion 18. The second filter 130 is affixed to the first filter 126 so as to be concentric with the through-hole portion 18. The front face side of the lens 22 of the infra-red camera 20 is covered by the second filter 130.

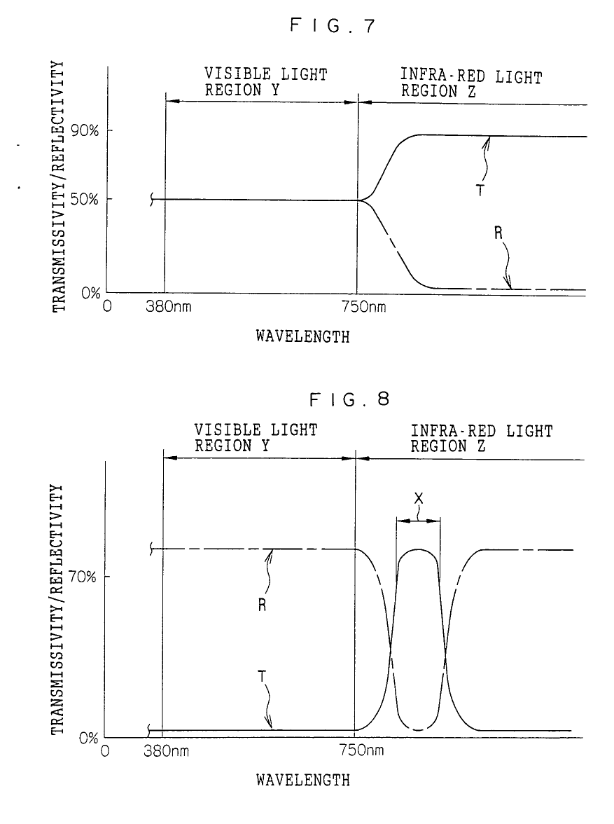

In FIG. 7, variations of reflectivity R and transmissivity T of the first filter 126 when a wavelength of illuminating light is varied are shown by graphs. The solid line depicts the transmissivity T and the broken line depicts the reflectivity R.

As can be seen from FIG. 7, spectral characteristics of the first filter 126 are that the transmissivity T and the reflectivity R of light with wavelengths in the visible light region Y are approximately equal, both being about 50%, and the transmissivity T of light with wavelengths in the infra-red wavelength range Z is high (and the reflectivity R is low). In other words, of light that is incident on the first filter 126, light with wavelengths in the visible light region is dimly reflected, and light with wavelengths in the infra-red light region is mostly transmitted.

In FIG. 8, variations of reflectivity R and transmissivity T of the second filter 130 when a wavelength of illuminating light is varied are shown by graphs. The solid line depicts the transmissivity T and the broken line depicts the reflectivity R.

As can be seen from FIG. 8, spectral characteristics of the second filter 130 are that the transmissivity T of light with wavelengths in the visible light region Y is low (and the reflectivity R is high). Further, in the infra-red light region Z, the transmissivity T is high (and the reflectivity R is low) for infra-red light with wavelengths in the range X which is appropriate to the infra-red camera 20 (specifically, light in the range of wavelengths from 850 nm to 950 nm), but the transmissivity T is low (and the reflectivity R is high) for infra-red light with wavelengths outside the range X. In other words, only infra-red light with wavelengths in the range X which is appropriate to the infra-red camera 20 passes through the second filter 130.

Next, operation of the present embodiment will be described.

When light with wavelengths in the visible light region Y is incident from the front face side of the first filter 126, of this light with wavelengths in the visible light region Y, roughly half is transmitted through the first filter 126, and the other half is reflected. In other words, the light with wavelengths in the visible light region Y that is incident on the first filter 126 is dimly reflected. Accordingly, if, for example, the front face side of the first filter 126 is oriented in a direction toward the vehicle operator, the vehicle operator can observe rearward of the vehicle by means of light with wavelengths in the visible light region Y that is dimly reflected by the first filter 126. Thus, if strong light comes from rearward of the vehicle, because the reflected light from the first filter 126 is dimmed, this light will not be dazzling for the operator. That is, an excellent anti-dazzle effect can be provided.

Because the first filter 126 has high transmissivity T of light with wavelengths in the infra-red light region Z, light with wavelengths in the infra-red light region Z that is illuminated from the infra-red LEDs 24 toward the front face side of the first filter 126 is transmitted from the rear face side to the front face side of the first filter 126, and illuminates the vehicle operator. Hence, the light with wavelengths in the infra-red light region that is reflected from the vehicle operator is again transmitted from the front face side to the rear face side of the first filter 126.

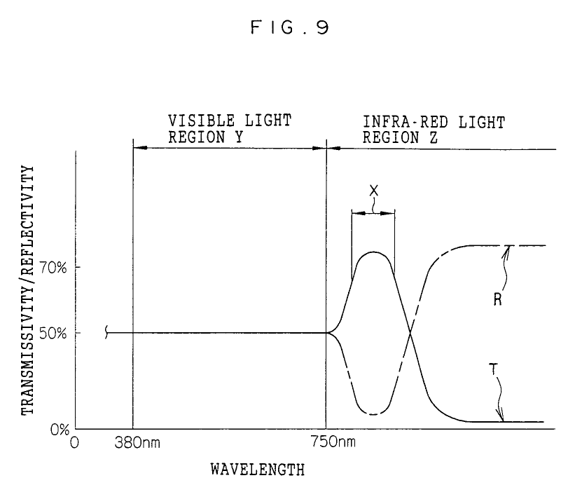

When the light with wavelengths in the infra-red light region that has been again transmitted through the first filter 126 is incident on the second filter 130, only the infra-red light with wavelengths within the range X, which is appropriate to the infra-red camera 20, is transmitted. That is, it can be considered that a single filter is provided at a front face portion of the lens 22, which filter has spectral characteristics combining the spectral characteristics of the first filter 126 and the spectral characteristics of the second filter 130. Specifically, as shown in FIG. 9, this would be a filter in which the transmissivity T and reflectivity R of light with wavelengths in the visible light region Y are approximately equal, both being around 50% and, in the infra-red light region Z, the transmissivity T of infra-red light with wavelengths within the range X which is appropriate to the infra-red camera 20 is high (and the reflectivity R is low), and the transmissivity T of infra-red light with wavelengths outside the range X is low (and the reflectivity R is high).

Because only infra-red light with wavelengths in the range X appropriate to the infra-red camera 20 is incident at the lens 22 of the infra-red camera 20, effects due to interference are slight and stable, and images with excellent contrast can be provided.

The second filter 130 can be made smaller, being of a size sufficient to cover the front face portion of the lens 22 of the infra-red camera 20. Therefore, implementing a number of uniform vapor deposition films at the second filter 130 is easier, and productivity is improved.

Accordingly, in the present embodiment, an anti-dazzle effect is provided by suitable reflectivity, in addition to which effects of interference on the built-in infra-red camera 20 are slight and stable, and images which express remarkable contrast can be provided.

Note that the second filter may have a form other than a circular plate. Further, the second filter may be provided so as to fit into the through-hole portion of the baseplate, and may be provided to be integral with the surveillance device at the front face portion of the lens.

What is claimed is:

1. An interior mirror comprising:
a housing including an opening;
a mirror including a mirror face and a mirror rear face at opposite sides thereof, the mirror being disposed so as to cover the opening of the housing, and the mirror including functionality as a filter which substantially reflects light of wavelengths in a visible light region that is incident from the mirror face side and substantially transmits light of wavelengths in an infra-red light region that is incident from either of the mirror face side and the mirror rear face side;
an image capture section disposed in the housing; and
a light-emitting section disposed in the housing, and capable of illuminating light including a wavelength in the infra-red light region at the mirror rear face.

2. The interior mirror of claim 1, wherein the light with wavelengths in the infra-red light region that is transmitted by the mirror is limited to a predetermined range which is appropriate to characteristics of the image capture section.

3. The interior mirror of claim 1, further comprising a baseplate for mounting of the image capture section and the light-emitting section.

4. The interior mirror of claim 1, wherein the image capture section comprises an infra-red camera.

5. The interior mirror of claim 1, wherein the light-emitting section comprises an infra-red LED.

6. An interior mirror comprising:
a mirror including a mirror face and a mirror rear face at opposite sides thereof, the mirror including functionality as a filter which substantially reflects visible light that is incident from the mirror face side and substantially transmits light other than visible light;
an image capture section including a lens facing the mirror rear face;
a light-emitting section disposed at the mirror rear face side of the mirror, and capable of illuminating light other than visible light at the mirror rear face; and
a shading member disposed between the lens and the light-emitting section, and capable of substantially preventing direct and indirect intrusion at the lens of illumination light from the light-emitting section.

7. The interior mirror of claim 6, wherein the shading member includes compressibility and is retained in a compressed state between the image capture section and the mirror.

8. The interior mirror of claim 6, wherein the shading member comprises a hollow cylindrical form with an inner diameter greater than an outer diameter of the lens, and is disposed concentrically with an optical axis of the lens.

9. The interior mirror of claim 6, wherein the light-emitting section is disposed at a vicinity of the image capture section.

10. The interior mirror of claim 6, further comprising a housing including an opening.

11. The interior mirror of claim 10, wherein the mirror is disposed so as to fill the opening of the housing.

12. The interior mirror of claim 10, wherein the image capture section and the light-emitting section are disposed in the housing.

13. An interior mirror comprising:
a mirror including a mirror face and a mirror rear face at opposite sides thereof, the mirror including functionality as a first filter whose transmissivity and reflectivity of light of wavelengths in a visible light region are approximately equal, and whose transmissivity of light of wavelengths in an infra-red light region is higher than reflectivity of the same;
an image capture section disposed at the mirror rear face side of the mirror;
a light-emitting section disposed at the mirror rear face side of the mirror, and capable of illuminating light including a wavelength in the infra-red light region at the mirror rear face; and
a second filter disposed between the mirror and the image capture section.

14. The interior mirror of claim 13, wherein, of light of wavelengths in the infra-red light region that is incident from the mirror side of the second filter, the second filter transmits light of wavelengths in a predetermined range which is appropriate to the image capture section.

15. The interior mirror of claim 13, wherein the image capture section comprises a lens facing the mirror rear face.

16. The interior mirror of claim 15, wherein the second filter comprises a circular plate form with an inner diameter greater than an outer diameter of the lens, and is disposed concentrically with an optical axis of the lens

17. The interior mirror of claim 13, wherein the light-emitting section is disposed at a vicinity of the image capture section.

18. The interior mirror of claim 13, further comprising a housing including an opening.

19. The interior mirror of claim 18, wherein the mirror is disposed so as to fill the opening of the housing.

20. The interior mirror of claim 18, wherein the image capture section and the light-emitting section are disposed in the housing.
